(19) United States
(12) Patent Application Publication
(10) Pub. No.: US 2022/0193619 A1
(43) Pub. Date: Jun. 23, 2022

(54) METHOD FOR PRODUCING PERMSELECTIVE MEMBRANE

(71) Applicants: KURITA WATER INDUSTRIES LTD., Tokyo (JP); NATIONAL UNIVERSITY CORPORATION KOBE UNIVERSITY, Kobe-shi (JP)

(72) Inventors: Takahiro KAWAKATSU, Tokyo (JP); Hideto MATSUYAMA, Kobe-shi (JP); Daisuke SAEKI, Kobe-shi (JP); Wakana MIYASHITA, Kobe-shi (JP)

(21) Appl. No.: 17/690,621

(22) Filed: Mar. 9, 2022

Related U.S. Application Data
(62) Division of application No. 16/484,543, filed on Aug. 8, 2019.

(30) Foreign Application Priority Data
Feb. 17, 2017 (JP) 2017-028152

(51) Int. Cl. B01D 69/02; B01D 69/10

(52) U.S. Cl. CPC B01D 69/02; B01D 61/025; B01D 69/10

(57) ABSTRACT

A method for producing permselective membrane includes preparing a support membrane having selective permeability and a lipid membrane containing a channel substance, the lipid membrane being formed on a surface of the support membrane. Excess lipids are removed with an acid or an alkali, and the support membrane has a permeation flux of 20 L/(m²·h) or more and a desalination capacity of 1% to 20% at a pressure of 0.1 MPa.

### CROSS-REFERENCE TO RELATED APPLICATION

This is a divisional application of Ser. No. 16/484,543 filed on Aug. 8, 2019, which claims a priority of Japanese Patent Application No. 2017-028152 filed on Feb. 17, 2017, the disclosure of which is incorporated herein.

### TECHNICAL FIELD

The present invention relates to a method for producing the permselective membrane.

### BACKGROUND ART

Reverse osmosis (RO) membranes have been widely used as permselective membranes in fields of desalination of seawater and brackish water, production of industrial water and ultrapure water, recovery of wastewater, and the like. The RO membrane is advantageous to achieve a high level of rejection of ions and low molecular weight organic substances. However, an RO membrane treatment needs higher operating pressure than treatments in which a microfiltration (MF) membrane or an ultrafiltration (UF) membrane is used. To improve water permeability of the RO membrane, an idea of providing a large surface area to a polyamide RO membrane by controlling a pleated structure of a skin layer has been implemented.

The RO membrane becomes contaminated by organic substances such as biological metabolite contained in water to be treated. A contaminated membrane has degraded water permeability and thus needs to be chemically washed in a regular manner. This washing results in degradation of the RO membrane and reduces a separation performance of the membrane.

As a method for preventing a membrane contamination, a method in which a permselective membrane such as an RO membrane is coated with a polymer having a phosphocholine group which is a hydrophilic group of a phospholipid has been known. A biomimetic surface is formed on the permselective membrane, which can be expected to show an effect of preventing the contamination caused by the biological metabolites (PTL1).

In recent years, an aquaporin, which is a membrane protein that selectively transports water molecules, has gained an attention as a water channel substance. It has been suggested that a phospholipid membrane incorporating this protein may have theoretically higher water permeability than that of a conventional polyamide RO membrane (NPL1).

As a method for producing a permselective membrane having a lipid membrane incorporating a water channel substance, the following methods have been proposed (PTL2).
1) A method in which a lipid bilayer membrane incorporating a water channel substance is sandwiched between porous supports.
2) A method in which a lipid bilayer membrane is incorporated inside a pore of a porous support.
3) A method in which a lipid bilayer membrane is formed around a hydrophobic membrane.

The method in which a lipid bilayer membrane is sandwiched between porous supports involves the following issues.

Although a pressure resistance of the lipid membrane is improved, the porous support itself is brought into contact with water to be treated and thus becomes contaminated.

A rejection is significantly decreased due to concentration polarization occurred in the porous support.

The water permeability may be lowered by the porous support acting as a resistance.

An RO membrane presents a problem in a pressure resistance of a phospholipid membrane when the RO membrane having a permselective membrane body surface is coated with a phospholipid membrane incorporating a water channel substance and functioning as a separating layer in a state where the phospholipid membrane is exposed.

PTL3 describes that a nanofiltration (NF) membrane is supported firmly by using a cationic phospholipid.

In PTL3, a support membrane is a dense NF membrane, and thus, the pressure resistance is improved. However, as the water permeability of the NF membrane itself is low, a permeation flux of a membrane to be produced is small. A pure water permeation flux of the NF membrane used in PTL3 is 11 L/(m²·h) at a pressure of 0.1 MPa, and a desalination rate is 50% to 55%. A permselective membrane in which a phospholipid membrane containing a channel substance is supported by the NF membrane that has been produced in Examples has a pure water permeation flux of 0.8 L/(m²·h) at a pressure of 0.1 MPa which is 1 L/(m²·h) or less.

PTL1: JP 6022827 B

PTL2: JP 2012-192408 A

PTL3: JP 6028533 B

NPL1: Pohl, P. et al., Proceedings of the National Academy of Sciences 2001, 98, 9624-9629.

### SUMMARY OF INVENTION

An object of the present invention is to provide a permselective membrane having excellent water permeability, a method for producing this permselective membrane, and a method for treating water using this permselective membrane.

The permselective membrane of the present invention includes a support membrane having selective permeability and a lipid membrane containing a channel substance, the lipid membrane being formed on a surface of the support membrane, wherein the support membrane has a permeation flux of 20 L/(m²·h) or more and a desalination capacity of 1% to 20% at a pressure of 0.1 MPa.

In one aspect of the present invention, the support membrane has a porous body and a charged polymer layer coating the porous body.

In one aspect of the present invention, the charged polymer layer includes a cationic polymer layer and an anionic polymer layer that are formed alternately.

In one aspect of the present invention, the porous body is an MF membrane or a UF membrane.

In one aspect of the present invention, the channel substance is at least one selected from a group consisting of gramicidin, amphotericin B, and a derivative of these substances.

A method for producing a permselective membrane of the present invention includes forming the lipid membrane on the support membrane and removing excess lipids with an acid or an alkali.

A method for treating water of the present invention is performed using the permselective membrane of the present invention.

### Advantageous Effects of Invention

In the present invention, a support membrane having a permeation flux of 20 L/(m²·h) or more and desalination capacity of 1% to 20% at a pressure of 0.1 MPa is used, and thus, the permselective membrane has excellent water permeability. That is, with this support membrane, a permeation flux is no longer dependent on the permeation flux of the support membrane, and a lipid membrane can be held by the support membrane. Therefore, the permselective membrane having a high permeation flux and pressure resistance can be produced.

### BRIEF DESCRIPTION OF DRAWINGS

FIG. 1 is a schematic explanatory drawing of experimental facility.

FIG. 2 is a schematic explanatory drawing of experimental facility.

FIGS. 3a-3d are graphs showing results of Examples and Comparative Example.

FIGS. 4a-4d are graphs showing results of Examples and Comparative Example.

FIG. 5 is a graph showing results of Examples.

### DESCRIPTION OF EMBODIMENTS

A permselective membrane of the present invention includes a support membrane having selective permeability and a lipid membrane containing a channel substance, the lipid membrane being formed on a surface of the support membrane. This support membrane has a permeation flux of 20 L/(m²·h) or more and has desalination capacity of 1% to 20% at a pressure of 0.1 MPa.

When an MF membrane or a UF membrane is used as a support membrane under the same conditions as those of PTL3, a pressure resistance at the time of supporting a phospholipid membrane containing a channel substance is 0.1 MPa or less.

In the present invention, as a support membrane, the support membrane having a pure water permeation flux of 20 L/(m²·h) or more, preferably 20 to 200 L/(m²·h), particularly preferably 20 to 100 L/(m²·h) and a desalination rate of 1 to 20% at a pressure of 0.1 MPa is used. This support membrane has characteristics intermediate between those of the NF membrane and the UF membrane. Use of such a support membrane allows a permselective membrane to maintain a high permeation flux and to have an improved pressure resistance.

### [Support Membrane]

As a support membrane, a membrane in which a surface of a porous body is alternately coated with a cationic polymer and an anionic polymer using a Layer-By-Layer (LBL) method may be used. The LBL method allows nanometer-scale control over a layer thickness by adsorbing and laminating a cationic polymer and an anionic polymer in an alternate manner using an electrostatic interaction between macromolecules. The LBL method can make a change in the permeation flux and the pressure resistance.

The porous body is not limited to a particular porous body. As the porous body, a porous membrane that is widely used for a water treatment and a gas separation including a polymer membrane such as a mixed cellulose ester membrane, a cellulose acetate membrane, a polyethersulfone membrane, and a polyvinylidene fluoride membrane, an inorganic membrane such as a silica membrane, a zeolite membrane, and an alumina membrane, and the like can be used, for example. As the porous body, an MF membrane or a UF membrane is suitably used.

In the LBL method, a cationic polymer is preferably coated on a surface of the porous body and washed. The membrane in this state is referred to as a 0.5-layer membrane. The cationic polymer is not limited to a particular polymer. As the cationic polymer, polydiallyldimethylammonium chloride (PDADMAC) having a quaternary ammonium group, and polyvinyl amidine, polyethyleneimine, polyallylamine, polylysine, and chitosan having an amino group can be used, for example.

Next, an anionic polymer is coated thereon and washed. The membrane in this state is referred to as a 1.0-layer membrane. The anionic polymer is not limited to a particular polymer. As the anionic polymer, sodium polystyrene sulfonate (PSS) and sodium polyvinyl sulfonate having a sulfonic acid group, sodium polyacrylate, sodium polymethacrylate, and sodium alginate having a carboxylic acid group, and the like can be used, for example.

Further, the cationic polymer is coated thereon and washed to produce a cationic 1.5-layer membrane on the outermost surface. As a result of these works, a support membrane in which a coating layer including an alternately-formed cationic polymer and anionic polymer layers is formed on the porous body is produced. The total number of the cationic polymer layer and the anionic polymer layer is preferably 1 to 5, and particularly preferably about 2 to 4.

### [Lipid Membrane]

As a lipid membrane formed on the support membrane, a phospholipid bilayer membrane is preferably used. Examples of a method for forming the phospholipid bilayer membrane on the surface of the support membrane include a Langmuir-Blodgett technique and a liposome fusion method. In the liposome fusion method, the support membrane produced as above is immersed in a liposome dispersion containing lipids having a charge opposite to that of the membrane surface. Accordingly, a phospholipid bilayer membrane is formed on the support membrane due to an electrostatic interaction.

As a method for preparing a liposome, a commonly used method such as a static hydration method, an ultrasonic method, and an extrusion method can be used. From a viewpoint of forming a membrane uniformly, a liposome of a single membrane is preferably used, and the extrusion method is preferably used so that the liposome of a single membrane is easily prepared.

A phospholipid constituting the liposome is not limited to a particular phospholipid. The phospholipid constituting the liposome preferably contains an anionic lipid when a surface potential of the support membrane produced as above is cationic and preferably contains a cationic lipid when the surface potential of the same is anionic. The phospholipid constituting the liposome preferably contains a neutral lipid in a range of 10 to 90 mol % from a viewpoint of stability of the liposome and membrane-forming properties.

The anionic lipid is not limited to a particular anionic lipid. As the anionic lipid, 1-palmitoyl-2-oleoylphosphatidylglycerol, 1,2-dioleoylphosphatidylglycerol, 1,2-dipalmitoylphosphatidylglycerol, 1-palmitoyl-2-oleoylphosphatidic acid, 1,2-dioleoylphosphatidic acid, 1,2-dipalmitoylphosphatidic acid, 1-palmitoyl-2-oleoylphosphatidylserine, 1,2-dioleoylphosphatidylserine, 1,2-dipalmitoylphosphatidylserine, 1-palmitoyl-2-oleoylphosphatidylinositol, 1,2-dioleoylphosphatidylinositol, 1,2-dipalmitoylphosphatidylinositol, 1′,3′-bis[1,2-dioleoyl-sn-glycero-3-phospho]-sn-glycerol, 1′,3′-bis[1,2-dipalmitoyl-sn-glycero-3-phosp ho]-sn-glycerol, or the like can be used.

The cationic lipid is not limited to a particular cationic lipid. As the cationic lipid, 1,2-dioleoyl-3-trimethylammoniumpropane, 1,2-palmitoyl-3-trimethylammoniumpropane, 1-palmitoyl-2-oleoyl-sn-glycero-3-ethylphosphocholine, 1,2-dioleoyl-sn-glycero-3-ethylphosphocholine, 1,2-dipalmitoyl-sn-glycero-3-ethylphosphocholine, 3β-[N-(N′,N′-dimethylaminoethane)-carbamoyl]cholesterol hydrochloride, or the like can be used.

The neutral lipid is not limited to a particular neutral lipid. As the neutral lipid, 1-palmitoyl-2-oleoylphosphatidylcholine, 1,2-dioleoylphosphatidylcholine, 1,2-dipalmitoylphosphatidylcholine, 1-palmitoyl-2-oleoylphosphatidylethanolamine, 1,2-dioleoylphosphatidylethanolamine, 1,2-dipalmitoylphosphatidylethanolamine, cholesterol, ergosterol or the like can be used.

When a lipid having a hydrocarbon group such as an alkyl group is used, a lipid having a hydrocarbon group such as an alkyl group having 12 to 24 carbon atoms is preferably used. This hydrocarbon group may have 1 to 3 double bonds or triple bonds.

As the channel substance, an aquaporin, gramicidin, amphotericin B, a derivative of these substances, or the like can be used.

As a method for introducing the channel substance into the liposome, a method in which the channel substance is mixed in advance during the preparation stage of the liposome, a method in which the channel substance is added after forming a membrane, or the like can be used.

When the phospholipid bilayer membrane is formed using the liposome fusion method, a phospholipid is preferably dissolved into a solvent along with a channel substance first. As the solvent, chloroform, a mixed solution of chloroform/methanol, or the like can be used.

The phospholipid and the channel substance are mixed to the extent that a proportion of the channel substance with respect to a total of these substances is preferably 1 to 20 mol %, particularly preferably 3 to 10 mol %.

Next, a 0.25 to 10 mM, or particularly a 0.5 to 5 mM solution containing a phospholipid and a channel substance is prepared and dried under reduced pressure to produce a dried lipid membrane. Pure water is added to this dried lipid membrane, which is heated to a temperature higher than a phase transition temperature of the phospholipid to produce a liposome dispersion having a spherical shell-like shape.

An average particle size of the liposome in the liposome dispersion used in the present invention is preferably 0.05 to 5μm, particularly preferably 0.05 to 0.4 μm.

The liposome dispersion and the support membrane are brought into contact with each other and kept in this state where the support membrane is in contact with the liposome dispersion for 0.5 to 6 hours, or particularly about 1 to 3 hours. As a result, the liposome is adsorbed on a surface of the membrane body to form a phospholipid bilayer membrane as a coating layer. After that, the membrane body with the coating layer is lifted up from the solution to remove excess lipids with an acid or alkali as necessary, and a resultant is subsequently washed with ultrapure water or pure water to produce a permselective membrane having a phospholipid bilayer membrane as a coating layer.

The phospholipid bilayer membrane has a thickness of preferably 1 to 10 layers, particularly preferably about 1 to 3 layers. A substance having a charge opposite to that of the phospholipid such as a polyacrylic acid, a polystyrene sulfonic acid, a tannic acid, a polyamino acid, polyethyleneimine, and chitosan may be adsorbed on a surface of this phospholipid bilayer membrane.

When permeated water is produced by a reverse osmosis membrane treatment or a forward osmosis membrane treatment using the permselective membrane of the present invention, a water permeate flow rate of 1×10⁻¹¹m³m⁻²s⁻¹Pa⁻¹ or more can be obtained at a driving pressure in a range of 0.05 to 3 MPa.

Examples of use of the permselective membrane of the present invention include desalination of seawater and brackish water, purification of industrial water, sewage, and tap water, and also concentration of fine chemicals, medicines, and food products. A temperature of water to be treated is preferably 10 to 40° C., particularly preferably about 15 to 35° C.

### EXAMPLES

Hereinafter, Examples and Comparative Example will be described. First, materials used for producing a support membrane, a method for producing the same, an evaluation method of membrane characteristics, and the like will be described.

### [Porous Body (Membrane Body)]

In Examples and Comparative Example below, a mixed cellulose ester membrane (a diameter of 25 mm, a pore size of 0.05 μm, manufactured by Merck Millipore) was used as a porous body (membrane body).

### [Charged Polymer]

As a cationic polymer, polydiallyldimethylammonium chloride (PDADMAC, an average molecular weight of 400,000 to 500,000, manufactured by Sigma-Aldrich) was used.

As an anionic polymer, sodium polystyrene sulfonate (PSS, an average molecular weight of 200,000, manufactured by Sigma-Aldrich) was used.

### [Preparation of Support Membrane]

<Support Membrane used in Comparative Example 1

The porous body (membrane body) was treated with a vacuum plasma processor (YHS-R, manufactured by SAKIGAKE-Semiconductor Co., Ltd) for 1 minute. The membrane body that has been subjected to a plasma treatment was immersed in a 1 g/L PDADMAC (polydiallyldimethylammonium chloride) solution for 5 minutes and then washed with pure water for 1 minute (0.5-layer membrane). Next, a resultant was immersed in a 1 g/L PSS (sodium polystyrene sulfonate) solution for 5 minutes and then washed with pure water for 1 minute (1.0-layer membrane). Further, a resultant was immersed in a 1 g/L PDADMAC solution for 5 minutes and then washed with pure water for 1 minute (1.5-layer membrane). A resultant membrane was immersed in a 10 mmol/L magnesium sulfate solution for 1 hour and then washed with pure water, which was used as a membrane for a phospholipid layer to be formed thereon.

<Support Membrane used in Example 1>

After forming the above-mentioned 1.5-layer membrane, the above-mentioned PDADMAC and PSS were alternately used to form the membrane. As a result, the support membrane having a laminated membrane of 3.5 layers membrane with the outermost surface being cationic was produced.

A pure water permeation flux and a desalination rate of each support membrane at an operating pressure of 0.1 MPa are shown in Table 1.

This characteristic was measured using an evaluation method described below.

TABLE 1

| | Pure water | Desalination |
|---|---|---|
| | permeation flux | rate |
| | [L/(m² · h)] | [%] |
| Support membrane for | 251 | 0 |
| Comparative Example | | |
| Support membrane for | 59 | 12 |
| Example | | |

(Operating pressure of 0.1 MPa)

In the support membrane for Comparative Example, as the number of layers produced using the LBL method was small, a sufficient coating layer is not formed. Thus, although the pure water permeation flux is high, the desalination rate is not obtained. On the other hand, in the support membrane for Example, satisfactory pure water permeation flux and desalination rate are obtained.

[Formation of phospholipid Bilayer Membrane]

<Phospholipid>

As an anionic phospholipid, 1-palmitoyl-2-oleyl-sn-glycero-3-phospho-(1′-rac-glycerol) (sodium salt) (POPG, manufactured by NOF Corporation) was used. As a neutral phospholipid, 1-palmitoyl-2-oleyl-sn-glycero-3-phosphocholine (POPC, manufactured by NOF Corporation) was used.

<Channel Substance>

As a channel substance, gramicidin A (GA, manufactured by Sigma-Aldrich) was used.

<Preparation of liposome Dispersion>

POPC and POPG at a molar ratio of 7:3 were dissolved in chloroform (a total concentration of 95 mol %). Into this solution, GA dissolved in trifluoroethanol was mixed such that a GA concentration is 5 mol % with respect to the phospholipid. An organic solvent was then evaporated with an evaporator. Pure water was added to a dried lipid thin membrane remained in a container, which was hydrated at 45° C. to prepare a liposome dispersion. A freeze and thawing method in which the container containing a resultant liposome dispersion was alternately immersed in liquid nitrogen and in a hot water bath at 45° C. for 5 times was performed to stimulate grain growth of the liposome dispersion. The liposome dispersion was extruded through a track-etched polycarbonate membrane (Nucrepore, manufactured by GE Healthcare) having a pore size of 0.1 μm, which was then diluted with pure water such that a lipid concentration is 0.4 mmol/L to prepare a liposome dispersion.

### <Formation of POPC/POPG Coated Membrane>

In this liposome dispersion, the above-described support membrane was immersed at 40° C. for 2 hours to allow the phospholipid to be adsorbed on the support membrane. After that, a resulting membrane was washed with pure water to remove phospholipids that have been excessively adsorbed on the support membrane, and a POPC/POPG coated membrane was formed thereon to produce a permselective membrane.

### [Evaluation Method of Membrane Characteristics]

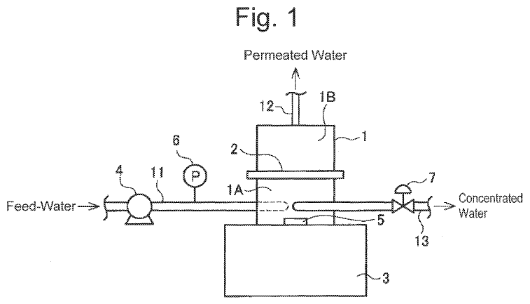

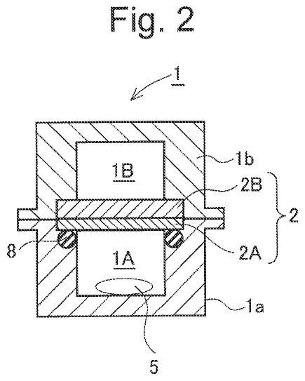

A pressure resistance of the membrane was evaluated with a flat membrane testing apparatus shown in FIGS. 1 and 2.

In this flat membrane testing apparatus, feed-water for an RO membrane is supplied to a raw water chamber 1A, which is provided in a lower side of a sealed container 1 in which the RO membrane has been disposed on a flat membrane cell 2, via a pipe 11 using a high-pressure pump 4. As shown in FIG. 2, the sealed container 1 is composed of a lower case 1a of a raw water chamber 1A side and an upper case 1b of a permeated water chamber 1B side, and the flat membrane cell 2 is fixed between the lower case 1a and the upper case 1b with an O-shaped ring 8. In the flat membrane cell 2, a permeated water side of the RO membrane 2A is supported by a porous support plate 2B. Raw water in the raw water chamber 1A provided under the flat membrane cell 2 is stirred by rotating a stirrer 5 with a stirring machine 3. A permeated water permeated through the RO membrane is taken out from the pipe 12 through the permeated water chamber 1B provided in an upper side of the flat membrane cell 2. A concentrated water is taken out from a pipe 13. The pressure inside the sealed container 1 is regulated by a pressure gauge 6 provided on the pipe 11 for the feed-water and a pressure-regulating valve 7 provided on the pipe 13 that is configured to take out the concentrated water.

Using the pressure-regulating valve 7, a pressure applied on the membrane surface was regulated at 0 to 0.6 MPa. As a liquid to be supplied, pure water was used when evaluating the pure water permeation flux. A 0.05 wt % sodium chloride solution was used as the liquid to be supplied when evaluating the desalination rate. The pure water permeation flux was determined from a weight change of a permeated liquid when the pure water was supplied. The desalination rate was calculated using the following equation based on an electric conductivity of the permeated liquid and a concentrated liquid when the sodium chloride solution was supplied.

Desalination rate=1—Electric conductivity of permeated liquid/Electric conductivity of concentrated liquid

### Comparative Example 1

A phospholipid bilayer membrane was formed on the above support membrane for Comparative Example (coating membrane of 1.5 layers) using the above method to produce a permselective membrane.

### Example 1

A phospholipid bilayer membrane was formed on the above support membrane for Example (coating membrane of 3.5 layers) using the above method to produce a permselective membrane.

### Example 2

A permselective membrane was produced in the same manner as in Example 1 except that when forming the phospholipid bilayer membrane, the phospholipid bilayer membrane was immersed in a liposome dispersion prepared so as to have a molar ratio of POPC and POPG being 3:7.

### Example 3

After a phospholipid bilayer membrane was formed in the same manner as in Example 1, a membrane surface was subjected to washing with an aqueous sodium hydroxide of pH 9.0 (alkali washing) to produce a permselective membrane.

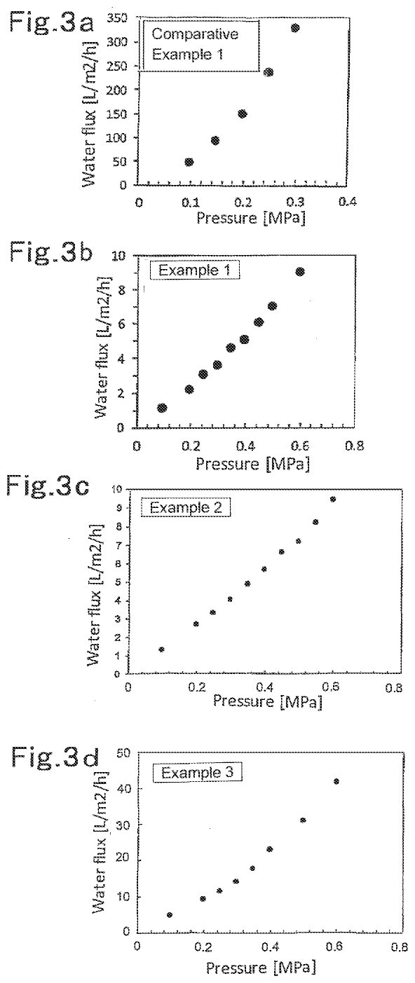

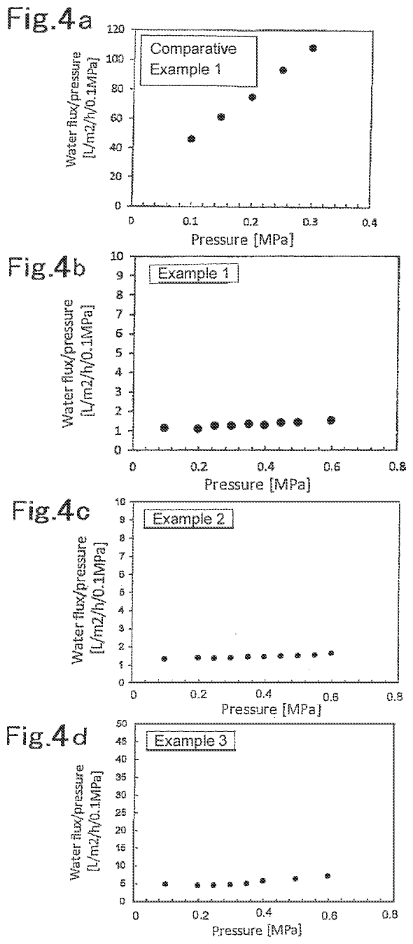

A dependency of the permeation flux (also referred to as water flux) on a pressure was measured on the permselective membranes produced in Comparative Example 1, Example 1, Example 2, and Example 3 using the above evaluation method, and their results are shown in FIGS. 3a to 3d, respectively. Further, a permeation flux per 0.1 MPa was determined based on the results in FIGS. 3a-3d, and results of the permeation flux plotted against an operating pressure are shown in FIGS. 4a to 4d.

According to FIGS. 3a to 3d, Comparative Example 1, Example 1, Example 2, and Example 3 all achieve a permeation flux of 1 L/(m²·h) or more at a pressure of 0.1 MPa. According to FIG. 4a, the permeation flux per 0.1 MPa is changed according to the pressure in Comparative Example 1, and this is possibly caused by the fact that breakdown of the membrane proceeds. On the other hand, FIGS. 4b, 4c, and 4d show that the permeation flux is maintained constant in Example 1, Example 2, and Example 3 even at 0.6 MPa, and therefore, these membranes are found to have a pressure resistance. In the case of Examples, it is considered that as the desalination capacity was present due to the formation of the coating layer using the LBL, a structure of the phospholipid bilayer membrane was able to be maintained. When the desalination rate was measured, the desalination rate in Comparative Example 1 was 0% and the desalination rate in Example 2 was, however, 96%. Accordingly, it is considered that while water molecules were permeated through GA as a channel substance, sodium chloride was rejected by the phospholipid bilayer membrane.

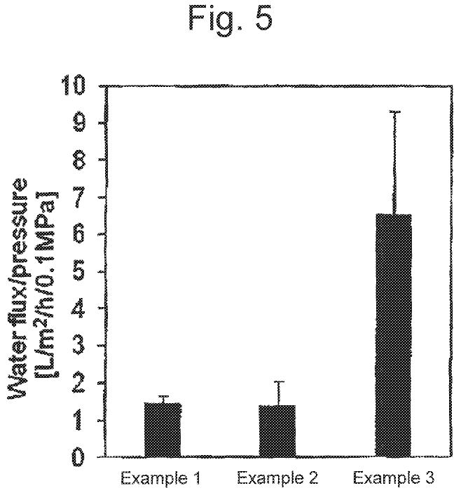

Results of the permeation flux measured at a pressure of 0.1 MPa are shown in FIG. 5. In Example 2, the same permeability as in Example 1 is obtained, which indicates that the membrane can be produced even when a proportion of the anionic lipid is changed. In Example 3, higher water permeability than that of Example 1 is obtained. It is considered that this is because the excess phospholipids were removed by alkali washing.

It is clear from the above Examples and Comparative Example that according to the present invention, the phospholipid membrane containing a channel substance can be stably supported by the support membrane, and the high water permeability and pressure resistance can be obtained. As a result, the present invention can be used as an RO membrane or a forward osmosis membrane.

Although the present invention is described in detail using a specific embodiment, it is clear for those skilled in the art that various modifications can be made without departing from the intention and scope of the present invention.

1. A method for producing permselective membrane, comprising:
preparing a support membrane having selective permeability and a lipid membrane containing a channel substance, the lipid membrane being formed on a surface of the support membrane,
wherein excess lipids are removed with an acid or an alkali, and
the support membrane has a permeation flux of 20 L/(m²·h) or more and a desalination capacity of 1% to 20% at a pressure of 0.1 MPa.

2. The method for producing the permselective membrane according to claim 1, wherein the permselective membrane has a permeation flux of 1 L/(m²·h) or more and a desalination capacity of 90% or more at a pressure of 0.1 MPa.

3. The method for producing the permselective membrane according to claim 1, wherein the support membrane has a porous body and a charged polymer layer coating the porous body.

4. The method for producing permselective membrane according to claim 3, wherein the charged polymer layer includes a cationic polymer layer and an anionic polymer layer that are formed alternately.

5. The method for producing permselective membrane according to claim 3, wherein the porous body is an MF membrane or a UF membrane.

6. The method for producing permselective membrane according to claim 1, wherein the channel substance is at least one selected from a group consisting of gramicidin, amphotericin B and a derivative thereof.
